(19) United States
(12) Patent Application Publication
(10) Pub. No.: US 2019/0078233 A1
(43) Pub. Date: Mar. 14, 2019

(54) PROCESS FOR PREPARING FIBERS FOR USE IN REJUVENATED LEATHER SUBSTRATES

(71) Applicant: PSIL HOLDINGS LLC, Tulsa, OK (US)

(72) Inventors: Joy K. NUNN, Bixby, OK (US); Susan H. BROWN, Tulsa, OK (US)

(21) Appl. No.: 16/082,815

(22) PCT Filed: Mar. 1, 2017
(86) PCT No.: PCT/US2017/020141

§ 371 Date: Sep. 6, 2018

Related U.S. Application Data
(60) Provisional application No. 62/305,260, filed on Mar. 8, 2016.

(51) Int. Cl. D01C 3/00; C08J 11/08; D02G 3/10

(52) U.S. Cl. CPC D01C 3/00; C08J 2375/04; D02G 3/10; C08J 11/08

(57) ABSTRACT

A process for converting post-industrial or post-consumer waste leather materials to leather fibers is disclosed. The process involves obtaining post-industrial or post-consumer waste leather materials with a surface finish, removing the surface finish, reduced the size of the materials to a size between about 0.5 and about 3 inches in length and in width, and adding a surfactant. After the surfactant has been added, the waste leather materials are again reduced in size to between 3 mm and 9 mm in length to form leather fibers, and a humectant and/or lubricant is added to the fibers, optionally after first opening up with steam. FTIR or other analytical chemistry can be used to identify the surface finishes before they are removed, which allows for selection of the most appropriate treatment to remove the finish.

### FIELD OF THE INVENTION

The following invention is generally in the field of composite materials including leather and a binding agent, and, more specifically, is focused on a process for producing fibers for use in producing a rejuvenated leather substrate.

### BACKGROUND OF THE INVENTION

A variety of consumer goods are prepared from leather, including leather seats, leather apparel, and leather sporting goods. During manufacture, a certain amount of post-industrial waste is produced, as the leather is cut to shape. There is also a certain amount of post-consumer waste generated as leather goods are discarded.

Numerous attempts have been made historically to utilize scrap leather in the development of products which strive to simulate genuine leather texture. A common application of this methodology is bonded leather, which is a plastic essentially composed of vinyl or polyurethane and contains approximately 17% leather fiber in its backing material. In such a material, scrap leather fiber is placed beneath the surface of the product, and dense overlay coats of PVC are applied. The product is then stamped to render a leather-like appearance. The majority of these endeavors have resulted in materials that are board or paper-like, due to a failure to establish a true connection between the new material and leather.

The primary source of raw materials for these products has been leather tanning scraps, which have no surface coating. It is worth noting that scrap leather with surface coatings, which outweigh those without coatings by billions of pounds annually, typically experience their end-of-life in the world's landfills. There are more than three billion pounds of leather waste landfilled each year.

It would be advantageous to provide compositions and methods for using the post-industrial and/or post-consumer leather waste and usable to replace leather in a variety of articles of manufacture. The present invention provides such compositions and methods.

### SUMMARY OF THE INVENTION

Processes for preparing leather fibers for use in producing rejuvenated leather products are disclosed. Products made using the leather fibers are also disclosed.

The process generally involves obtaining a quantity of post-industrial or post-consumer waste leather materials, which tend to have a surface finish. This surface finish is ideally removed, or substantially removed, as it tends to interfere with further process steps once the fibers have been produced. Accordingly, the next step in the process involves treating the waste leather materials to remove all or substantially all of the surface finish. After the finish has been removed, the waste leather materials are reduced to a size between about 0.50 inches to 3 inches in length and in width, and are generally square or rectangular.

Once the leather materials have been reduced in size, a surfactant is added. The surfactant can be a nonionic, anionic, cationic, or zwitterionic surfactant.

Once the surfactant has been added, the waste leather materials are again reduced in size, such that at least around 92% of the total fibers are in a size between 3 mm and 9 mm in length, with fewer than 5% of total fibers being less than 3 mm long and fewer than 3% of the total fibers being longer than 9 mm, thereby forming leather fibers.

It is important to maintain the humidity/lubricity of the fibers, so the next step involves adding a humectant and/or lubricant to the leather fibers. In one embodiment, the fibers are opened up using steam before the humectant and/or lubricant is added. The moisture content of the fibers is typically in the range of around 6 to around 8 percent by weight before being treated with steam, and between around 10 and around 30 percent by weight after being treated with steam.

Post-industrial or post-consumer waste leather materials include, but are not limited to, vegetable tanned leather, chrome tanned leather, bark tanned leather, and the like. A synthetic polymeric coating is commonly present, to give color or texture to the leather. Animals which are used for their leather include cows, goats, lambs, crocodiles, and alligators, and post-industrial and/or post-consumer waste leather is frequently from the shoe, automotive, apparel, personal leather goods, saddle making, or furniture businesses.

Once a source of leather, such as post-industrial or post-consumer waste leather materials to be rejuvenated is obtained, the process can further involve obtaining data on the type of polymer coating applied to the leather, so as to facilitate its removal. Data can also be obtained on the types of treatments or finishes that the incoming waste leather may have received during production, as well as data on the color and shade of leather.

One way to determine the type of polymer coating on the leather involves FTIR (fourier transform infrared) spectroscopy. The FTIR can be performed by dissolving the polymer in a solvent, then removing the solvent to yield a polymer. If the polymer is too opaque, it can be crushed into a powder, mixed with potassium bromide, and formed into a thin disk for use in generating an FTIR scan. Another way to perform FTIR is to use reflective FTIR, where the IR passes only a few microns into a surface to be tested. Still another way is to use an abrasive that does not absorb light in the desired portion of the IR spectrum to scratch the polymer surface, then to perform an FTIR screen on the abrasive surface.

The spectrum can be stored, if desired, in a computer database. Ideally, the spectrum is screened against a library of other spectra, and the type of polymer can be identified by computer matching. While the exact member of a class of polymers may not be identified, typically each polymer type will provide an FTIR spectra with certain key peaks, making it possible to identify the type of polymer coating on the leather.

In this manner, one can obtain data for each bale of incoming waste leather, related to the type of coating on the leather, and this information can be stored in a database.

Data can also be obtained relating to target product requirements. Target data includes the type of coating applied to the leather and the types of chemicals used to treat the leather before it was coated.

The types of solvents and other conditions used to remove a polymer coating will, of course, vary depending on the nature of the coating. Similarly, the types of treatments to the leather after the coating has been removed will vary depending on the end use of the leather. For these reasons, it is useful to have a way to quickly determine the best set of parameters for removing the coating and applying chemical treatments to the leather after the coating has been removed.

To accomplish these goals in an efficient manner, the process involves using a database with pre-stored data with information on the types of solvents and other conditions for removing a given polymer coating from leather, as well as pre-stored data on how to treat leather fibers, once the polymer has been removed, to obtain a set of desired properties. A predetermined algorithm or set of algorithms is used to generate a “rejuvenation processing recipe.” This recipe specifies bales information relating to bales of incoming waste fabrics selected for further leather rejuvenation processing, and leather rejuvenation processes information relating to a series of processes, and corresponding process parameters for each of the series of processes for processing the selected bales of incoming waste leather materials to obtain rejuvenated fibrous materials specific to the target product requirements.

It also improves efficiency if one can apply a single set of coating removal conditions to a number of different bales of waste leather, so the information stored on the database can also be used to identify those bales with similar enough coatings that the bales can be combined and subjected to a common treatment. In one embodiment of the process, bales with similar coatings are combined before the coating is removed.

If further improves efficiency if one can apply a single set of chemical treatments to a batch of leather from which the coating has been removed. Once a plurality of bales have been identified as being susceptible to a single set of conditions to remove the polymer coating, and a set of treatment chemicals has been identified to meet a given set of performance criteria for a finished rejuvenated leather product, the bales can be combined and treated to remove the coating, and then treated to provide the desired properties.

Accordingly, once bales of incoming waste fabrics have been selected for further rejuvenation processing according to the information stored on the database for the bales regarding a “rejuvenation processing recipe,” the selected bales can be subjected to the process steps specified by the rejuvenation processes information of the rejuvenation processing recipe. In this manner, one can obtain rejuvenated fibrous materials specific to the target product requirements.

This can be accomplished, for example, by opening the bales of leather materials, placing them in a suitable reactor or mixing tank, and treating the specific leather waste materials to remove their polymer coating. In one embodiment, the resulting “cleansed” waste leather materials can be mixed with virgin leather in an intimate mixing step to provide “intimately blended” leather pieces. This process creates a homogeneous blend of all the leather materials, which can be relatively important due to the unique origins of the leather scraps in the initial part of the process.

The “cleansed” waste leather materials, by themselves, or in an intimate blend with virgin leather materials, can be subjected to a gradual size reduction process by cutting the leather pieces.

The leather materials can then be subjected to a series of chemical and/or enzymatic treatments, which can include, for example, components which rehydrate the leather materials. Rehydration can be performed, for example, using natural oils, such as fat liquors. Formic acid can be used to reduce the pH for a rechroming process, and to help with chemically fixing dyehouse chemicals to the leather at the end of a dyehouse process. Chrome syntans and chromium sulfate can be used during rechroming to improve the softness of the final leather. Resins and polymers can be used to give fullness and a tight grain to the leather. Dyes are used to color the leather, with dyeing auxiliaries used to help disperse the dyes evenly.

The fibers can then be processed through specialized size reduction equipment. This can provide for a more harmonized raw material for downstream processing. In one embodiment, the fibers measure between 3 mm and 9 mm in length, dependent on the downstream application requirements. Fewer than 5% of total fibers should be less than 3 mm long and fewer than 3% of fibers should be longer than 9 mm, with the optimum fiber length necessary for a quality non-woven leather replacement product measuring from 6 mm to 7 mm. If, for example, the final fiber application is leather yarn spinning, then the optimal fiber lengths would measure between 4 mm and 6 mm.

The resulting “humectified” and fibrous materials can be subjected to further fiber conditioning, for example, using one or more of the chemicals listed above, to obtain and solidify refined fibers with desirable physical and chemical properties. These properties can be determined, at least in part, by the selection of the chemicals used in the conditioning step.

The refined fibers of all lengths can then be extracted for final baling.

Further process steps can be performed to convert the refined fibers into further products, such as rejuvenated leather materials, including composite leather materials.

The present invention will be better understood with reference to the following detailed description.

### BRIEF DESCRIPTION OF THE FIGURES

FIG. 1 is a graphical representation of the overlap of an FTIR spectrum of a sample of PVC and a stored reference spectrum for PVC.

FIG. 2 is a graphical representation of a best-fit comparison of an FTIR spectrum of a sample believed to be PVC with a stored reference spectrum for PVC. Other possible fits are shown, including vinylidene chloride/vinyl chloride copolymers, carboxylated PCV, various vinyl chloride/vinyl acetate/vinyl alcohol mixtures, various vinyl chloride vinyl acetate copolymers with varying amounts of vinyl acetate, and a vinylidine chloride/acrylonitrile copolymer.

### DETAILED DESCRIPTION

Processes for preparing leather fibers for use in producing rejuvenated leather products are disclosed. Products made using the leather fibers are also disclosed. This rejuvenation technology is designed to use all types of leather waste materials to create quality leather systems that have design characteristics that are equal to, or surpass, those of virgin leather due to engineering of the substrates for their desired downstream application.

Briefly, the process involves determining the type of polymer(s) used to coat post-industrial or post-commercial waste, and, optionally, determining other treatments which had been applied to the waste. By knowing the types of polymeric and other treatments, a specific set of treatment conditions can be applied to remove the treatments, leaving a leather composition either free of, significantly free of, or significantly reduced in the amount of these treatments. This enables the user to essentially start fresh with leather, and convert the leather to desired products.

Before this can take place, however, a series of conditions have to be developed to remove the various treatments. Post-industrial and post-consumer leather waste is largely derived from the shoe industry, the furniture industry, the automotive industry, including other types of transportation, and blue shavings from tanning operations. It is typically, but not always the case that shoe waste leather is coated with polyurethane (PU) or polyvinyl chloride (PVC). Furniture leather waste is typically tanned or suede, and coated with PU. Automotive leather products are also tanned or suede, and coated with PU. Blue shavings from tanning operations typically have chromic oxide.

Briefly, the process involves segregating waste leather bales, and analyzing the types of treatments applied to the leather. To create quality leather fibers from different types of inputs, it can be important to analyze each batch, and the types of polymer coatings and, optionally, other pertinent treatments, are analyzed and logged into a database. As used herein, the database is referred to as a “Rejuvenated Leather Database System,” or “RLDS.” Storing the information in a database can be critical to the overall strategic quality of the process, as it stores and utilizes information regarding the materials to be recovered. The information stored typically includes one or more of source data of the materials such as origin; tanning processes; finish chemicals; and/or surface finishes used during the cutting and sewing of the end product. These intricate quality control measures qualify and quantify raw materials for downstream rejuvenation. Once the raw materials have been entered into the RLDS, homologous or reasonably homologous materials can be batched and processed simultaneously, thus maximizing the use of available reactors.

Once the treatments are removed from the leather scraps, the resulting material can be subjected to “fiberization,” where the leather is cut or chopped into relatively small fibers.

Additional details on the processes described herein are provided below.

### I. Determination of Polymer Coatings on Scrap Leather Materials

The surface characteristics of the scrap leather raw materials can analyzed by one or more tests, including, but not limited to, FTIR (Fourier Transform Infrared Spectroscopy) or Standard ASTM testing specific to industry standards.

Once the surface characteristics have been determined, an appropriate set of extraction conditions can be selected and employed to strip the surface materials from the raw leather scrap. This can revert the leather fibers to their natural state without any significant contamination.

Analytical Techniques for Identifying Polymers

FTIR (Fourier Transform Infrared Spectroscopy) is an effective analytical tool for screening and profiling polymer samples. FTIR testing can provides quantitative and qualitative analysis for polymer and plastic materials, such as the types of polymers used to treat leather. Representative ASTM protocols include ASTM E168 and ASTM E1252.

A typical infrared scan is generated in the mid-infrared region of the light spectrum. The mid-infrared region is from 400 to 4000 wavenumbers, which equals wavelengths of 2.5 to 25 microns (10-3 mm).

FTIR functions by identifying chemical bonds in a molecule by producing an infrared absorption spectrum. A material's absorbance of infrared light at different frequencies produces a unique “spectral fingerprint,” based upon the frequencies at which the material absorbs infrared light and the intensity of those absorptions. The resulting spectral scan (absorbance or transmittance) is usually specific to a general class of material. For example, the spectral scan of a polyurethane would be different than that of a polyester, but all polyester scans have unique similarities, such as carbonyl (C═O) peaks and C—O single bond peaks.

FTIR polymer identification of an unknown is done by matching the material's infrared peaks, either transmittance or absorbance, to the peaks of similar infrared scans of known materials. The better the match, the higher the certainty for correctly identifying the unknown polymer.

An FTIR spectral analysis can easily identify classes of polymers such as Nylons, Polyesters, Polypropylenes, Polycarbonates, Acetals, or Polyethylenes. However, an FTIR spectral scan alone should not be expected to identify the type of Nylon or Polyester, identify a Polypropylene or Acetal as a homopolymer or copolymer, or determine whether the Polyethylene is a high density or low density material.

The spectrum is not typically obtained on the leather itself, because light may not pass through the leather, and if it did, the peaks in the leather would, in any case, potentially interfere with the peaks from the polymer. However, light will typically pass through a pellet made from the polymer. If light does not pass through the polymer pellet, a small amount of polymer can be mixed with a material such as potassium bromide, which does not absorb light in the desired infrared range, to form a disk.

One way to determine the polymer content is to take a representative sample of leather to be repurposed, and extract the polymer using a solvent capable of dissolving any polymer coat. For example, a chlorinated solvent like dichloromethane or chloroform will likely dissolve any type of polymer coat, though it may not be desirable to extract polymer coats from leather on commercial scale using this type of solvent. The solvent can be evaporated to provide a solid, which can be formed into a thin disk, or mixed with potassium bromide and formed into a thin disk, which then allows passage of light in the infrared range. This solid can be subjected to FTIR, and the resulting spectra produces a profile of the sample, a distinctive molecular fingerprint that can be used to easily screen and scan samples for many different components. Polymer and Plastics FTIR is an effective analytical instrument for detecting functional groups and characterizing covalent bonding information.

Another approach which can be used is reflective FTIR. With this technique, the infrared beam only enters a few microns into the sample surface. If the surface is contaminated, one can perform a solvent wash of the sample's surface before carrying out the reflective FTIR screening.

Samples the size of a single resin pellet can also be scanned by reflective FTIR. Samples, which can be easily tested by reflective FTIR, include polymer pellets, opaque samples, fibers, powders, and liquids.

In another approach, one can obtain a sample of the polymer coating using an abrasive pad, where the abrasive is one without significant absorption in the infrared spectrum. Examples include diamond or silicon carbide. For example, Perkin Elmer has an FTIR technique known as ATR, which can be performed in as little as a few minutes.

A spectral scan of a reference material can be generated and stored in a spectral library database, if desired. A stored reference scan will allow all future material scans to be compared back to the same earlier scan.

Matching the unknown infrared spectrum to known spectra can be done manually or with the help of a computerized program. Computerized spectral searches can quickly compare an unknown spectrum to a very large number of spectra located in multiple databases in a very short period of time.

Computerized spectral matches to the spectral scan of an unknown polymer coating can be presented, for example, from best to worst with assigned certainty ratings. Computer programs are very helpful for comparing unknown spectral scans to those of known materials, though it is still helpful for a skilled analytical chemist to examine the computer selected spectral matches to ensure that sample identifications are both accurate and complete.

While computer matching programs may experience difficulties with subtle differences, since all that matters is identifying a set of chemicals for removing a given polymer coating, and the removal conditions are typically broadly applicable to a range of polymers within each class of polymers, subtle differences are unlikely to be of significant concern.

The Perkin Elmer COMPARE method is a representative example of an FTIR database which stores spectra, where one can perform a Euclidean full spectrum comparison using search libraries with a number of stored spectra for the types of polymers commonly used in leather treatments. If desired, one can verify the type of polymer, for example, using SIMCA (Soft Independent Modeling by Class Analogy). This is a chemometric approach, which uses comprehensive statistical information.

Using an appropriate algorithm for comparing FTIR spectra, such as the Perkin Elmer COMPARE algorithm, one can develop a library of spectradevelopment, which can include intuitive search parameters, with filters to improve discrimination between similar materials. A system like this can be used for materials verification, with appropriate filters for emphasizing chemical differences.

The library of FTIR spectra to be compared with the FTIR spectra of a given sample can include anywhere from 1 to 100,000 spectra, preferably 1 to 10,000 spectra, and, most preferably, from 1 to 1,000 spectra. Given the relatively small set of polymers used to coat the leather, and the fact that many types of polymers within the same class can be extracted using the same or similar conditions, the libraries need not be very large. Further, the comparison can be limited to key peaks of interest, such as urethane peaks in polyurethanes, ester peaks in polyesters, and the like.

FTIR (Fourier Transform Infrared Spectroscopy) is often used with other molecular spectroscopy techniques, including TGA, DRIFTS, FTIR/TGA, NMR, GC/MS, LC/MS, UV/Vis spectroscopy, NIR and Raman scattering. FTIR combined with these techniques provides significant complementary data regarding a polymer molecule's molecular structure. FTIR, when used together with these other analytical techniques, can prove very effective in identifying unknown plastics and polymeric materials.

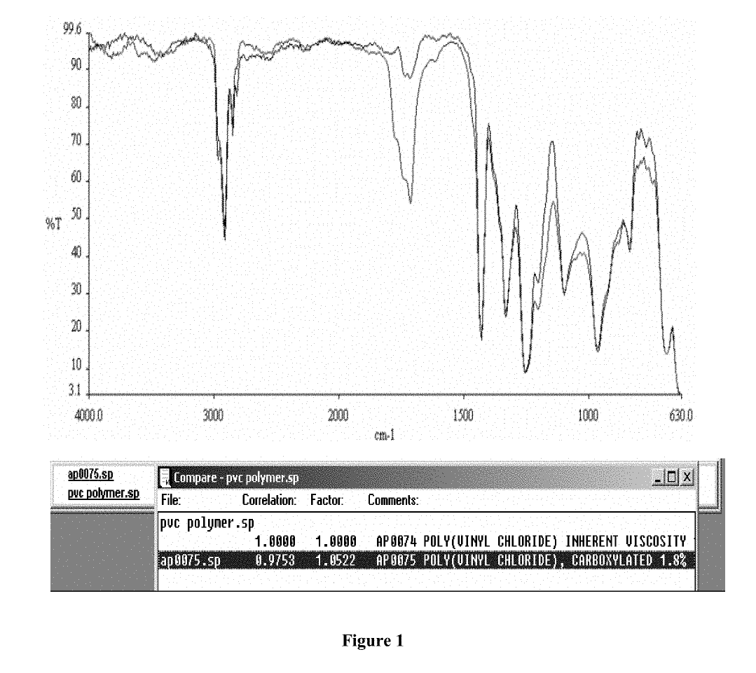

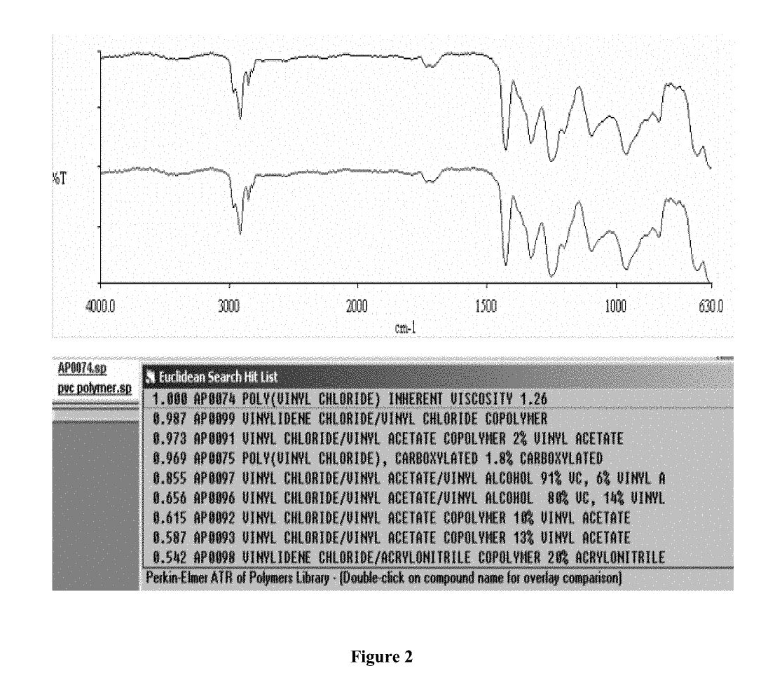

Using the teachings herein, and common knowledge to those in the art, spectral scans from an unknown polymer coating can be analyzed to determine the nature of the polymer by comparing the scan to spectral scans of known materials that are stored in a computer-based library. A representative comparison of overlapping FTIR spectra of a PVC polymer (information provided by Perkin Elmer) is shown in FIGS. 1 and 2. One of the FTIR spectra is from a stored library, and the other is of a sample that was screened.

ASTM Leather Standards

ASTM's leather standards are instrumental in the determination, testing, and evaluation of the various physical and chemical properties of different forms of leather. These standards help users and producers of leather goods all over the world in assessing their materials for good quality and workmanship towards satisfactory use.

### List of Leather Standards Developed by ASTM:

### D1913—00(2015) Standard Test Method for Resistance to Wetting of Garment-Type Leathers (Spray Test)

### D2096—11 Standard Test Method for Colorfastness and Transfer of Color in the Washing of Leather

### D6014—00(2015) Standard Test Method for Determination of Dynamic Water Absorption of Leather Surfaces

### Chemical Analysis

### D2617—12 Standard Test Method for Total Ash in Leather

### D2807—93(2015) Standard Test Method for Chromic Oxide in Leather (Perchloric Acid Oxidation)

### D2810—13 Standard Test Method for pH of Leather

### D2868—10(2015) Standard Test Method for Nitrogen Content (Kjeldahl) and Hide Substance Content of Leather, Wet Blue and Wet White

### D3495—10(2015) Standard Test Method for Hexane Extraction of Leather

### D3790—79(2012) Standard Test Method for Volatile Matter (Moisture) of Leather by Oven Drying

### D3897—91(2012) Standard Practice for Calculation of Basicity of Chrome Tanning Liquors

### D3898—93(2015) Standard Test Method for Chromic Oxide in Basic Chromium Tanning Liquors

### D3913—03(2015) Standard Test Method for Acidity in Basic Chromium Tanning Liquors

### D4653—87(2015) Standard Test Method for Total Chlorides in Leather

### D4654—87(2015) Standard Test Method for Sulfate Basicity in Leather

### D4655—95(2012) Standard Test Methods for Sulfates in Leather (Total, Neutral, and Combined Acid)

### D4906—95(2012) Standard Test Method for Total Solids and Ash Content in Leather Finishing Materials

### D4907—10(2015) Standard Test Method for Nitrocellulose in Finish on Leather

### D5356—10(2015) Standard Test Method for pH of Chrome Tanning Solutions

### D6016—06(2012) Standard Test Method for Determination of Nitrogen, Water Extractable in Leather

### D6017—97(2015) Standard Test Method for Determination of Magnesium Sulfate (Epsom Salt) in Leather

### D6018—96(2012) Standard Test Method for Determining the Presence of Lead Salts in Leather

### D6019—15 Test Method for Determination of Chromic Oxide in Basic Chromium Tanning Liquors (Ammonium Persulfate Oxidation)

### Fats and Oils

D5346—93(2009) Standard Test Method for Determination of the Pour Point of Petroleum Oil Used in Fat liquors and Softening Compounds

### D5347—95(2012) Standard Test Method for Determination of the Ash Content of Fats and Oils

D5348—95(2012) Standard Test Method for Determination of the Moisture Content of Sulfonated and Sulfated Oils by Distillation with Xylene

### D5349—95(2012) Standard Test Method for Determination of the Moisture and Volatile Content of Sulfonated and Sulfated Oils by Hot-Plate Method

### D5350—95(2012) Standard Test Method for Determination of Organically Combined Sulfuric Anhydride by Titration, Test Method A

### D5351—93(2009) Standard Test Method for Determination of Organically Combined Sulfuric Anhydride by Extraction Titration, Test Method B

### D5352—95(2012) Standard Test Method for Determination of Organically Combined Sulfuric Anhydride Ash-Gravimetric, Test Method C

### D5353—95(2012) Standard Test Method for Determination of Total Desulfated Fatty Matter

### D5354—95(2012) Standard Test Method for Determination of Total Active Ingredients in Sulfonated and Sulfated Oils

### D5355—95(2012) Standard Test Method for Specific Gravity of Oils and Liquid Fats

### D5439—95(2012) Standard Test Method for Determination of Sediment in Moellon

### D5440—93(2009) Standard Test Method for Determining the Melting Point of Fats and Oils

### D5551—95(2012) Standard Test Method for Determination of the Cloud Point of Oil

### D5553—95(2012) Standard Test Method for Determination of the Unsaponifiable Nonvolatile Matter in Sulfated Oils

### D5554—15 Standard Test Method for Determination of the Iodine Value of Fats and Oils

### D5555—95(2011) Standard Test Method for Determination of Free Fatty Acids Contained in Animal, Marine, and Vegetable Fats and Oils Used in Fat Liquors and Stuffing Compounds

### D5556—95(2011) Standard Test Method for Determination of the Moisture and Other Volatile Matter Contained in Fats and Oils Used in Fat Liquors and Softening Compounds

### D5557—95(2011) Standard Test Method for Determination of Insoluble Impurities Contained in Fats and Oils Used in Fat Liquors and Stuffing Compounds

### D5558—95(2011) Standard Test Method for Determination of the Saponification Value of Fats and Oils

### D5559—95(2011) Standard Test Method for Determination of Acidity as Free Fatty Acids/Acid Number in the Absence of Ammonium or Triethanolamine Soaps in Sulfonated and Sulfated Oils

### D5560—95(2011) Standard Test Method for Determination of Neutral Fatty Matter Contained in Fats and Oils

### D5562—95(2011) Standard Test Method for Determination of the Acidity as Free Fatty Acids/Acid Number in the Presence of Ammonium or Triethanolamine Soaps

### D5564—95(2011) Standard Test Method for Determination of the Total Ammonia Contained in Sulfonated or Sulfated Oils

### D5565—95(2011) Standard Test Method for Determination of the Solidification Point of Fatty Acids Contained in Animal, Marine, and Vegetable Fats and Oils

### D5566—95(2011) Standard Test Method for Determination of Inorganic Salt Content of Sulfated and Sulfonated Oils

### Vegetable Leather

### D2875—00(2010) Standard Test Method for Insoluble Ash of Vegetable-Tanned Leather

### D2876—00(2010) Standard Test Method for Water-Soluble Matter of Vegetable-Tanned Leather

### D4899—99(2009) Standard Practice for Analysis of Vegetable Tanning Materials—General

### D4900—99(2009) Standard Test Method for Lignosulfonates (Sulfite Cellulose) in Tanning Extracts

### D4901—99(2009) Standard Practice for Preparation of Solution of Liquid Vegetable Tannin Extracts

### D4902—99(2009) Standard Test Method for Evaporation and Drying of Analytical Solutions

### D4903—99(2009) Standard Test Method for Total Solids and Water in Vegetable Tanning Material Extracts

### D4904—99(2009) Standard Practice for Preparation of Solution of Liquid Vegetable Tannin Extracts

### D4905—99(2009) Standard Practice for Preparation of Solution of Solid, Pasty and Powdered Vegetable Tannin Extracts

### D6401—99(2009) Standard Test Method for Determining Non-Tannins and Tannin in Extracts of Vegetable Tanning Materials

### D6402—99(2014) Standard Test Method for Determining Soluble Solids and Insolubles in Extracts of Vegetable Tanning Materials

### D6403—99(2014) Standard Test Method for Determining Moisture in Raw and Spent Materials

### D6404—99(2014) Standard Practice for Sampling Vegetable Materials Containing Tannin

D6405—99(2014) Standard Practice for Extraction of Tannins from Raw and Spent Materials

### D6406—99(2014) Standard Test Method for Analysis of Sugar in Vegetable Tanning Materials

### D6407—99(2014) Standard Test Method for Analysis of Iron and Copper in Vegetable Tanning Materials

### D6408—99(2014) Standard Test Method for Analysis of Tannery Liquors

### D6410—99(2014) Standard Test Method for Determining Acidity of Vegetable Tanning Liquors

### Wet Blue

### D4576—08(2013) Standard Test Method for Mold Growth Resistance of Wet Blue

### D6656—14b Standard Test Method for Determination of Chromic Oxide in Wet Blue (Perchloric Acid Oxidation)

### D6657—14ae1 Standard Test Method for pH of Wet Blue

### D6659—10(2015) Standard Practice for Sampling and Preparation of Wet Blue for Physical and Chemical Tests

### D6714—01(2015) Standard Test Method for Chromic Oxide in Ashed Wet Blue (Perchloric Acid Oxidation)

### D6715—13 Standard Practice for Sampling and Preparation of Fresh or Salt-Preserved (Cured) Hides and Skins for Chemical and Physical Tests

### D6716—08(2013) Standard Test Method for Total Ash in Wet Blue or Wet White

### D7476—08(2013) Standard Test Method for Brine Saturation Value of Cured (Salt-Preserved) Hides and Skins

### D7477—08(2013) Standard Test Method for Determining the Area Stability of Wet Blue Submersed in Boiling Water

### D7584—10(2015) Standard Test Method for Evaluating the Resistance of the Surface of Wet Blue to the Growth of Fungi in an Environmental Chamber

### D7674—14a Standard Test Method for Hexane/Petroleum Ether Extract in Wet Blue and Wet White

### D7816—12 Standard Test Method for Enumeration of Halophilic and Proteolytic Bacteria in Raceway Brine, Brine-Cured Hides and Skins

### D7817—12 Standard Test Method for Enumeration of Yeast and Mold in Raceway Brine, Brine-Cured Hides and Skins

### D7818—12 Standard Test Method for Enumeration of Proteolytic Bacteria in Fresh (Uncured) Hides and Skins

### D7819—12 Standard Test Method for Enumeration of Yeast and Mold on Fresh (Uncured) Hides and Skins

II. Chemical and/or Enzymatic Treatments to Remove Polymers and Other Treatments

The leather scrap begins the rejuvenation process by entering a suitable treatment reactor. In one embodiment, the reactor is a rotating cylindrical vat or a series of such vats. Ideally, each vat has a material processing capability of 50 to 2000 pounds of leather scrap.

The system can use a “negative pressure” method to transport materials. In this sequence, gravity is employed as the scrap is deposited from above each unit. Each vat can then be closed, for example, using a pressure seal, and filled with an appropriate chemical or series of chemicals specific for removing a given polymer coating from the scrap leather.

The treatment chemicals can include, for example, one or more organic solvents and/or one or more enzymes. Steam can also be used. The chemicals penetrate the leather materials.

The types of organic chemicals and/or enzymes used to remove the surface finishes include, but not limited to, dilute acid or concentrated neutral salt solutions. Representative organic solvents include halogenated alcohols, preferably fluorinated alcohols such as tetrafluoroethylene (TFE) and hexafluoro isopropanol (HFIP), hexafluoroacetone, chloro alcohols, which can be used in conjugation with aqueous solutions of mineral acids and dimethylacetamide, preferably containing lithium chloride, ethyl acetate; 2-butanone (methyl ethyl ketone), diethyl ether; ethanol; cyclohexane; water; dichloromethane (methylene chloride); tetrahydrofuran; dimethylsulfoxide (DMSO); acetonitrile; methyl formate and various solvent mixtures. HFIP and methylene chloride are particularly desirable solvents. In some embodiments, water is added to the solvents.

Additionally, it is often desirable, although not necessary, for the solvent to have a relatively high vapor pressure to promote the later stabilization of an electrospinning jet to create a fiber as the solvent evaporates. Once the synthetic polymers are removed from the leather materials, each of these have their own “end-of-life” that is described in subsequent technology related to this patent.

It can be useful in removing the polymer coating from the leather scraps to not only contact the leather scraps with an appropriate solvent, but to also mix the leather scraps and solvent. The mixing can involve a similar type of agitation as is used in a washing machine, or can involve stirring, or, in a preferred embodiment, the vats can slowly rotate. The amount of rotation can be based on time, number of rotations, or other suitable ways to determine an appropriate endpoint. For example, RLDS data can correlate the type of coating to be removed with the type of enzymes or chemicals to be used, and/or the number of rotations necessary to remove the surface finishes of the leather submitted for rejuvenation.

Once leather surface finish removal has been achieved, each unit can be flushed with an aqueous fluid, which causes organic polymeric coatings and any organic solvents used to remove them to rise above the top surface of the aqueous fluid. The organic coatings and/or solvents can then be removed, for example, by suction, decantation, by draining from appropriately placed ports, or other means known to the art.

The water can be drained from the vat. If desired, the “cleansed” leather and aqueous fluid can be passed through a centrifuge equipped with a centrifuge bag, which allows water to pass through, and retains the leather.

The resulting “cleansed” leather material can now be positioned on a conveyor, such as a stainless steel grate conveyor, where it can be transported to the next station in the leather rejuvenation process. Alternatively, it can be physically moved using other means, such as carts, fork trucks, lifts, and the like.

For example, once the materials pass through the cleansing area, a conveyor can move them to one or more blending units, where they can be joined with “harmoniously-blended” virgin leather materials which had never been finished or pre-treated with synthetic polymers, but were scrap materials from the tanning process or had been naturally tanned.

The materials can then be intimately blended, then conveyed to an initial cutter to pre-fiberize the leather segments.

Creating a homogeneous blend of all the leather materials can be of particular importance due to their unique origins in the initial part of the process. Intimate blending can be accomplished, for example, when a “delivery condenser,” or a hopper, carrying raw material positions itself over the large blending boxes. A representative size for the blending boxes is approximately 10 feet wide and 20 feet long, but bigger or smaller boxes can be used depending on the volume of production required.

The introduction of the materials into the blending boxes can be accomplished by negative pressure, for example, gravity. In one aspect of this embodiment, the materials are moved through duct work using air pressure, where a change in air pressure in a desired location allows the material to drop into the blending box.

In one embodiment, a spiked apron is used to retrieve material from one end of the box, and pneumatically deliver it into a vertical transfer unit. This can result in a cross section of material becoming a harmonious blend ready for delivery to the next process for pre-fiberization. This action allows for a homogeneous blend for the remainder of the process.

Fiberizing the Treated Leather Scrap

The purified leather scrap, which is optionally intimately blended with virgin leather, then moves through to a station where it can be fiberized, and humidified and/or moisturized based on its final finished product application.

Before the treated scrap leather is fiberized and converted into a yarn, it can be important to prepare the scrap leather to accept humidity and lubrication. In one embodiment, a humectant or surfactant is used in one zone, and a lubricant in a second zone. In another embodiment, both a humectant and a surfactant are used in a single zone. However, the use of separate zones can be preferred, as it is easier to reuse/recycle humectants/surfactants that pass through the leather if they are treated in separate zones.

In one embodiment, an initial zone, or surfactant zone, occurs prior to fiberization, while lubrication occurs subsequent to fiberization.

Temperature control can be important in both of these zones. These treatment zones are crucial steps in the process that will bring suppleness back into the leather fibers and fabrics. The “surfactant zone” employs a rotating mixing unit that creates a homogeneous blend of treatment on the leather pieces and adds a humectant via steam then lubricants into the leather.

The temperature of the steam application in the surfactant zone is recommended to not exceed 135° C. Varied selections of protease enzymes and/or surfactants with a pH optimum of 9-10 can be used to facilitate the moisture take-up of the skin/hide/fibers. Representative protease enzymes include, but are not limited to, fungal protease, pepsin, trypsin, chymotrypsin, papain, bromelain, and subtilisin.

In the case where the scrap being treated is the trimmings of a tanning process, the initial cleansing of the fibers to remove synthetic polymers is not required, so the raw materials can flow directly to the intimate blending stage, if intimate blending is desired, and can be further processed through the surfactant zone.

Once this process is complete, the materials can be removed from the Catalytic Vapor unit and transported to an area where the size of the leather scraps can be reduced.

While any appropriate transportation method can be used to move the material from the “surfactant zone” to a “cutting zone,” in one embodiment, a conveyor is used.

In one embodiment, the scraps are reduced in size in two separate stages. In the first stage, the scraps are cut to a size in the range of between about 0.5 and about 3 inches in length and in width, and are generally square or rectangular in shape.

Material size reduction in the initial stage can be performed by a guillotine cutter, and all subsequent fibers produced from this action which are less than 3 mm long can be filtered out of the process. The segregated fibers which are less than 3 mm long can then be moved to a secondary process where they are used in an end-use application appropriate to their size.

A secondary fiber reduction can occur by passing the materials through an enclosed tunnel equipped with a series or rotary knives. In another embodiment, the materials can be passed through pairs of cylinders with a coat of wire or small pins. The paired cylinders rotate inwardly in a manner that combs or extracts the fibers. In a third embodiment, the materials can be passed under or through cylindrical cutting heads with spiral cutting edges. The edges of the cutting instrument have pointed projections along the spiral ridges which also acts in a combing and extraction method of the fibers. The resulting fiber can then be further refined, if necessary, through the rotary cutting blades allowing for even more accurate fiber length processing.

The focus of this fiber reduction station is to return fibers to the process which measure between 3 mm and 9 mm in length, dependent on the downstream application requirements. Fewer than 5% of total fibers should be less than 3 mm long and fewer than 3% of fibers should be longer than 9 mm, with the optimum fiber length necessary for a quality non-woven leather replacement product measuring from 6 mm to 7 mm. If, for example, the final fiber application is leather yarn spinning, then the optimal fiber lengths would measure between 4 mm and 6 mm.

Once the leather scraps have been reduced in size to fibers, and the fibers have been appropriately sized, the fibers can be moistened, humidified, and/or lubricated. Lubrication creates drape, softness and strength. Leather in its natural state is a non-woven material where the fibrils of the fiber have grown together. After fiberization, the natural leather has been deconstructed. In the rejuvenation of this product, it is advantageous to reconstruct the semblance of nature by returning the fibers to a natural non-woven material. Leather making is the science of utilizing acids, bases, salts, enzymes and tannins to dissolve fats and non-fibrous proteins and strengthen the bond between the collagen fibers. This objective can be accomplished, for example, by re-hydrating the leather fibers in a first treatment zone. Salts can be used to cleanse the fibers; enzymes and tannins can be replaced, in order to restore a more natural material from something which was ultimately destined for landfill or incineration.

In one embodiment, a treatment zone is used to contact the leather fibers with proteases or other enzymes, which facilitate the leather fibers in the take-up of tannins and/or lubricating oils.

The etymology of the word “tannin” is quite old and reflects a technology rich in tradition. “Tanning” (waterproofing and preserving) was the word used to describe the process of transforming animal hides into leather by using the plant extracts of different plant species and their various parts. A range of tannins can be employed in the treatment process. including vegetable tannins like Pyrogallol, which consists of polyphenolic systems of two types: hydrolyzed tannins (the pyrogallol class), whose main constituents are esters of glucose with acids such as chebulic, ellagic, gallic and m-digallic; and the condensed (catechol) tannins which are based on leuco-anthocyanidins and like-substances joined together in a manner not clearly understood. The pyrogallol tannins may be hydrolyzed by acids or enzymes and include the gallotannins (from plant galls) and the ellagitannins, which are characteristic of divi divi, myrabolans, sumac, tara, valonea, and other well-known tannins. The condensed tannins are not hydrolysable, and are characteristic of hemlock, mangrove, quebracho, wattle, and the like. Condensed tannins are more astringent, i.e. they tan more rapidly than the pyrogallols, have larger molecules, and are less well buffered. These can be placed into the leather in an aqueous solution with or without the addition of one or more enzymes.

Examples of plant species used to obtain tannins for the tanning process are Wattle (Acacia sp.); Oak (Quercus sp.); Eucalyptus (Eucalyptus sp.); Birch (Betula sp.); Willow (Salix Caprea), Pine (Pinus sp.); and Quebracho (Scinopsis Balansae). The most important aspects of the choice of tannin used are the high molecular weight and high conformational mobility.

Oils are typically added after the tannins are added. The oils re-lubricate the leather fibers. Examples of oils that can be used include, but are not limited to, neatsfeet oil, mink oil, and a product such as Meropol Oil 805.

In one embodiment, the fibers are blended with oils, and the oils are allowed to penetrate into the fibers. In another embodiment, which is more preferred, the fibers are contacted with steam, which can be high pressure steam, which allows the fibers to swell. The moisture content of the fibers ideally rises to around 10-30 percent by weight of the fibers. Then, once the fibers are swollen, oil is applied to the fibers, and can penetrate the fibers better than before the fibers were swollen. The process by which fibers are first swollen using steam, and then impregnated with one or more chemicals/enzymes, is referred to herein as a “catalytic steam” process. While water is not a true catalyst, it is not a true reactant, but it swells the fibers, it assists with penetration of the chemicals/enzymes, and then is removed when the fibers return to an ambient moisture content of between around 6 and around 8 percent moisture.

These oils are ideally added to the leather fibers at a temperature which does not exceed 125° C. A dwell time of about two to about twelve hours is recommended. After an appropriate dwell time, the materials can sent to final packaging and moved on to a secondary process, where the fibers are converted to finished goods.

According to the above disclosure, a person skilled in the art may make suitable modifications and changes to the above embodiments. Therefore, the present invention is not limited by the above disclosure and the embodiment described. Modifications and changes to the present invention should fall within the scope of the present invention as defined by the claims. Besides, although certain technical terms have been used throughout the specification, the technical terms are intended for ease of explanation and are not intended to restrict the present invention in any ways.

1. A process for making leather fibers from post-industrial or post-consumer waste leather materials, comprising:
a) obtaining a quantity of post-industrial or post-consumer waste leather materials which have a surface finish,
b) treating the waste leather materials to remove all or substantially all of the surface finish,
c) chopping the waste leather materials to a size between about 0.5 and about 3 inches in length and in width,
d) adding a surfactant to the chopped waste leather materials,
e) cutting the chopped waste leather materials such that at least around 92% of the total fibers are in a size between 3 mm and 9 mm in length, with fewer than 5% of total fibers being less than 3 mm long and fewer than 3% of the total fibers being longer than 9 mm, thereby forming leather fibers, and
f) adding a humectant and/or lubricant to the leather fibers.

2. The method of claim 1, wherein the fibers are subjected to a treatment with steam before the humectant and/or lubricant is added.

3. The process of claim 1, wherein the polymer coating is selected from the group consisting of

4. The process of claim 1, wherein the solvent used to remove the surface coating is selected from the group consisting of Representative organic solvents include halogenated alcohols, preferably fluorinated alcohols such as tetrafluoroethylene (TFE) and hexafluoro isopropanol (HFIP), hexafluoroacetone, chloro alcohols, which can be used in conjugation with aqueous solutions of mineral acids and dimethylacetamide, preferably containing lithium chloride, ethyl acetate; 2-butanone (methyl ethyl ketone), diethyl ether; ethanol; cyclohexane; water; dichloromethane (methylene chloride); tetrahydrofuran; dimethylsulfoxide (DMSO); acetonitrile; methyl formate and various solvent mixtures. HFIP and methylene chloride are particularly desirable solvents. In some embodiments, water is added to the solvents.

5. The process of claim 1, wherein the surfactant is an anionic, non-ionic, cationic, or zwitterionic surfactant.

6. The process of claim 1, wherein the humectant and/or lubricant is neatsfeet oil, mink oil, or Meropol Oil 805.

7. The process of claim 1, wherein the surface coating is polyurethane or polyvinyl chloride.

8. The process of claim 1, further comprising performing a reflective FTIR analysis on the waste leather material to determine the type of coating before the coating is removed.

9. The process of claim 8, wherein there are multiple batches of waste leather materials, and batches with the same or similar coatings are combined for treatment to remove the coatings using a solvent system that is specific for dissolving the particular coating.

10. The process of claim 1, further comprising intimately mixing the waste leather materials from which the coatings have been removed with virgin leather materials, forming a random mixture of treated waste leather materials and virgin leather materials.
